(19) United States
(12) Patent Application Publication
(10) Pub. No.: US 2011/0016000 A1
(43) Pub. Date: Jan. 20, 2011

(54) CREATING CONTENT EXPERIENCE WITH VIDEO WIDGETS

(76) Inventors: Brian David Cronshaw, Seattle, WA (US); Kamesh Chander Tumsi Dayakar, Atlanta, GA (US); Daniel C. Lemon, Redmond, WA (US); Darris A. Hupp, Seattle, WA (US); Russell M. Eames, Redmond, WA (US); Patrick J. Neill, Sammamish, WA (US); Christopher P. Macey-Cushman, Seattle, WA (US); Robert E. Moyer, Kirkland, WA (US)

Correspondence Address: MICROSOFT CORPORATION, ONE MICROSOFT WAY, REDMOND, WA, 98052, US

(21) Appl. No.: 12/503,164

(22) Filed: Jul. 15, 2009

(51) Int. Cl. G06Q 30/00; G06F 3/00; G06F 17/00; G06F 15/16; G06F 3/048

(52) U.S. Cl. 705/14.55; 715/749; 715/719; 715/209; 705/14.49; 705/14.73; 709/231; 715/838; 715/234

(57) ABSTRACT

Widgets on a web page may interact with each other in order to provide a rich, responsive content experience. In one example, the widgets that are provided may include a video player, a video gallery, a metadata pane, or any other components. The gallery may allow a user to select a video to be played, and the gallery may communicate the user's choice to the video player. The video player may then play the video that the user has selected. A container may be provided that allows widgets in the container to interoperate with each other. For example, the container may provide an interface that facilitates communication between a widget and the container, and between plural widgets. A tool may be provided that allows a designer to configure the widgets.

### BACKGROUND

Over the last several years, the content that web sites provide has become increasingly sophisticated. In the early years of the web, web sites typically contained text and some simple graphics, which might be organized into frames. More recently, users expect web sites to offer a rich multimedia experience, which typically includes not only text and still graphics, but also video, audio, interactive programs, etc. Video content has become commonplace on many commercial web sites.

When a web site provides video content, the web site typically contains a video player that is designed to play a specific video. For example, one component of a sports web site might be a video that shows a clip from one of the day's sporting events. The web site operator might frequently change the video that is shown on the web site so that successive visits to the same web site would cause the user to see different videos. Some web site operators might even have a set of videos that are offered in succession, or at random, so that reloading the same page would yield a different video. However, the implementation of videos on web sites generally involves including, on the web page, a video player that plays a specific video. So, if the user loads a web page, part of the web page is a video player (typically in the form of a “widget”) that plays the specific video that the web site operator has chosen. Reloading the page might result in downloading a widget that plays a different video. However, the functionality of these video widgets tends to be relatively simple and inflexible. For example, the widget might be able to play a specific video, and may not be able to do much else. Video widgets typically do not contain rich functionality to interact with other content on the web page.

### SUMMARY

Video widgets may be designed with functionality that allows them to interact with other content, such as content that appears on the same page as the video widget. For example, a web page may be provided with a video player, a gallery containing thumbnails of other videos (which allows the user to select one of the videos in the gallery to be played on the player), a metadata pane to show information about the video that is being played, some advertisements, or any other type of components. The various components could be implemented as widgets that interact with each other. For example, if the user selects a video from the gallery, the video player that is on the page could then play the selected video. The metadata pane could show information about the video that is currently being played. The particular ads that are being shown could be based on what videos the user selects. In this sense, the components on the page could be said to interact with each other. Moreover, these components could interact with other information on the web page. For example, if the page contains the text of a news story, the gallery widget could extract keywords from the story, and could show videos that relate to those keywords. Any type of interaction between the widgets, or between widgets and other content, may be performed.

One way to implement video widgets that interact with each other is to provide a widget container that facilitates interaction among the widgets. For example, the widgets could implement an interface that is known to the container, and the container's interface could be known to the widgets. The container may provide mechanisms through which one widget may interact with other widgets. For example, when a user selects a video from the gallery, the gallery widget may be able to use the container to tell the video widget which video to play. Or, the gallery widget could use the container to determine what text content appears on the page, and could use this information to determine what videos to show in the gallery.

A tool may be provided in order to allow a web page designer to configure the widgets. For example, the tool may allow a designer to select the dimensions and/or location at which the various widgets will be shown on a web page. Or the tool could allow the designer to select different features of particular widgets (e.g., whether the video will have a mute button, a fast forward button, etc.). The tool could allow the designer to specify any type of parameter of the various widgets.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example web page on which various widgets are displayed.

FIG. 2 is a block diagram of an example container that may be used to facilitate interaction among widgets, or between widgets and other information.

FIG. 3 is a block diagram of an example configuration interface that may be used with a configuration tool.

FIG. 4 is a block diagram of an example way in which components may interact to create a content experience.

FIG. 5 is a flow diagram of an example process by which a web page containing widgets may be designed and/or used.

FIG. 6 is a block diagram of example components that may be used in connection with implementations of the subject matter described herein.

### DETAILED DESCRIPTION

The operators of web sites seek to offer increasingly sophisticated content. In the early days of the web, content was typically limited to text and graphics. However, computer users now typically expect commercial web sites to provide an interactive multi-media experience. One aspect of this experience is to display videos on a web site. For example, a web site may include a widget that functions as a video player, so that the user may play a video directly on the web page that he or she is visiting.

Video widgets typically have relatively simple and limited functionality. For example, a video widget that appears on a page may be able to play a particular video. However, such widgets typically cannot be used to play other videos. If the user requests to view another video, typical web sites download a new page with a new video widget that is designed to play the selected video. Moreover, the video widget normally does not interact with other widgets (or other content) that may be present on the page.

The subject matter described herein provides mechanisms through which widgets can interact with each other to provide a rich video content experience. Various widgets related to the video experience (e.g., a video player, a gallery, a metadata pane, etc.) may be provided on the web page. These widgets may interact with each other, or with other content on the web site. For example, the user may interact with the gallery to select a video to be viewed. When the user selects a video from the gallery, the gallery may cause the video player to play the selected video (e.g., by providing the video player with an indication of the video that the user wants to view). There may be other content on the page (e.g., current news items), and the particular videos that are offered in the gallery may be based on content that is in the page. For example, the gallery widget may examine the content that exists on the page, and may communicate with a video search engine to choose an appropriate selection of videos that relate to that content. The videos offered to the user by the gallery then may be based on a dynamic evaluation of what is on the page. Other widgets could be offered to perform other actions, and these widgets could interact with each other, or could interact with other content on the page.

Widgets could be configurable, in order to customize the content experience offered by a web page. For example, a set of pre-defined, generic widgets could be provided that implement a video player, a gallery, a metadata pane, etc., and a content designer could configure these widgets. For example, a content designer could configure the size of a widget, its appearance, what controls are offered in the widget, what sources the widget obtains content from, etc. A tool may be provided that allows the content designer to set the configuration parameters for the widget.

When widgets are to be used together on a web page, the widgets may be provided as part of a widget container. The widget container may provide the functionality to allow widgets to interact with each other. For example, the container may expose functions that allow one widget to send a message to another widget. Moreover, in order to interact with the container the widgets may implement callbacks that the container invokes to send information to the widget. (The information that is sent to the widget may be information that the container generates, or may be information that the container passes to one widget on behalf of another widget.)

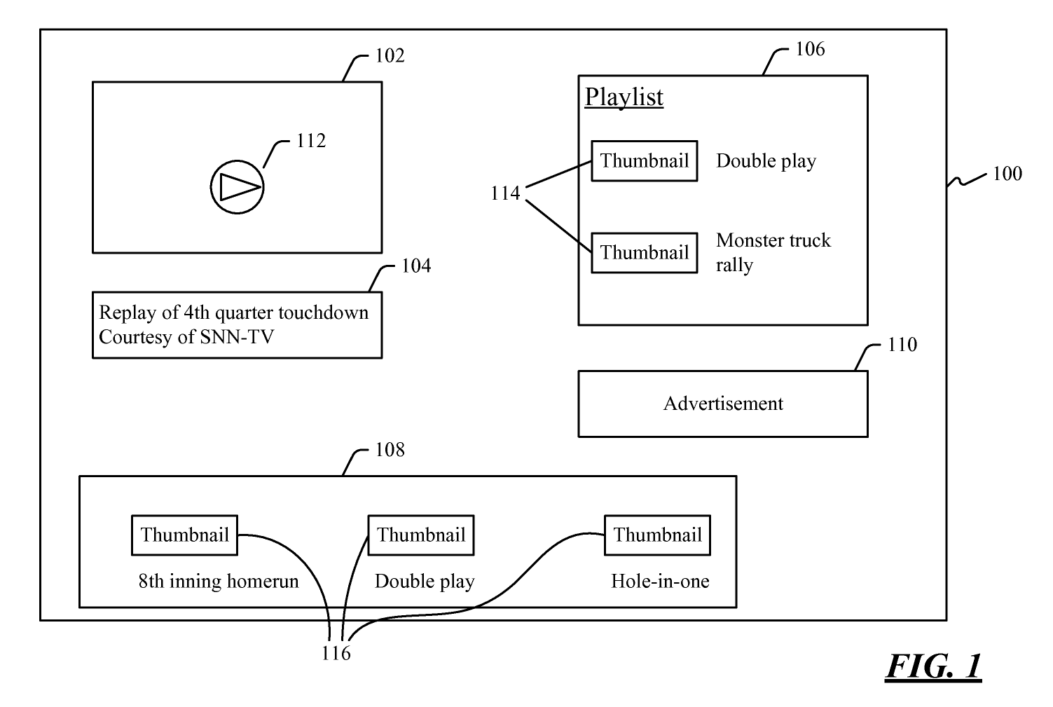

Turning now to the drawings, FIG. 1 shows an example web page 100 on which various widgets are displayed. The widgets on web page 100 may interact with each other, or with other content on web page 100. Thus, each widget may tailor its actions based on the content that exists web page 100, or based on actions taken by other widgets, or based on a user's interaction with other widgets.

For example, the widgets that appear on web page 100 may include a video player 102, a metadata pane 104, a playlist 106, a gallery 108, and an advertising pane 110. These widgets may be implemented using Dynamic HTML (DHTML), Flash, Java, the MICROSOFT SILVERLIGHT system, or any other appropriate technology. In general, web browsers are equipped to execute such widgets (or are extensible to execute such widgets through plug-ins, ActiveX controls, etc.).

Video player 102 is a widget that renders video, such as streaming video. Video player 102 may have some interactive controls, such as play button 112, which allow a user to direct the operation of video player 102.

Metadata pane 104 is a widget that displays information (e.g., metadata) concerning the video that video player 102 is playing. For example, a video may contain data such as the video's title, a short description, the length of the video, the source of the video, the date on which the video was encoded, etc. Metadata pane 104 may display some or all of this information.

Playlist 106 may display a list of videos that a user has already played. Playlist 106 could display this information in any form. For example, playlist 106 may include thumbnails 114 of videos that the user has played during the current browsing session (or at some point in the past). Playlist 106 may also display the titles of videos, or any other information about the videos.

Gallery 108 may display a list of videos that are available to be played. The provider of web page 100 may have a list of videos that the provider wants to promote, and these videos could be displayed by gallery 108. For example, web page 100 may be a sports web page operated by a television sports network, and the operator of that network may want to guide the user to videos that promote future sporting events to be shown on the network. The videos that are shown in the gallery could also be based on some assessment of user preference. For example, if the user has viewed several video clips from baseball games, then gallery 108 could show the user additional baseball videos. As another example, the particular videos that are shown in gallery 108 could be based on some combination of what content the provider of web page 100 wants to promote, and what videos the provide believes the user would want to see. Gallery 108 may learn what the user is interested in seeing through its interaction with other widgets. For example, if playlist 106 contains a historical record indicating that the user has viewed several baseball videos, then gallery 108 may learn, by communicating with playlist 106, that the user is interested in baseball. (Of course, the provider of web page 100 may implement an appropriate privacy policy to prevent information learned about the user from being used in an inappropriate manner.)

The videos that are listed in gallery 108 could be displayed in any appropriate manner. For example, gallery 108 could show the user a set of thumbnails 116 of videos and/or a set of titles of the videos.

Advertising pane 110 may display ads to be viewed by a user of web page 100. Advertising pane 110 may choose ads to be displayed based on information from other widgets on web page 100. For example, if a user of web page 100 has watched several videos on baseball, then advertising pane 110 might select advertisements for sports paraphernalia. On the other hand, if the user watches several movie trailers, then advertising pane 110 might select advertisements that are related to the entertainment industry. (As noted above, an appropriate privacy policy could be used to prevent information about the user from being used in an inappropriate manner.)

Web page 100 contains examples of content that could be implemented by widgets. However, a web page implemented in accordance with the subject matter herein could contain additional types of content. Or, such a web page could omit some of the content shown in web page 100. Or, some of the content in a web page could be implemented by widgets, and other content in the same page could take the form of something other than a widget. For example, web page 100 might display static advertising content, rather than using an advertising pane widget.

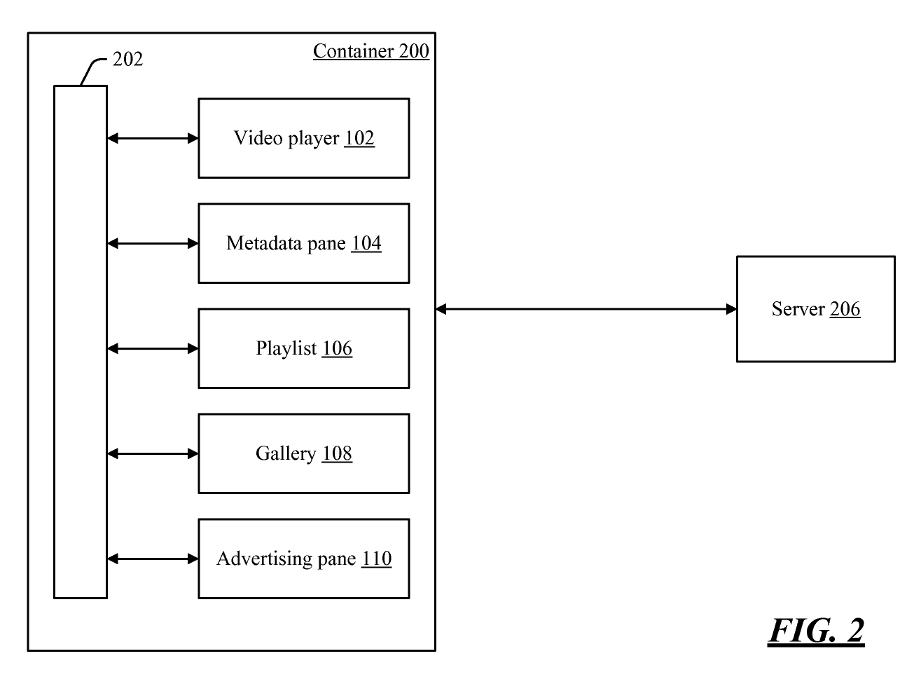

The various widgets shown in web page 100 may interact with each other (or with any other content on the page) using a widget container. A container may provide an interface through which widgets may interact with their surroundings. For example, the container may expose an interface that allows one widget to make a request of another widget, or that allows a widget to determine the presence of text or other content on the page on which the widgets appear. FIG. 2 shows an example container 200 that may be used to facilitate interaction among widgets, or between widgets and other information.

Video player 102, metadata pane 104, playlist 106, gallery 108, and advertising pane 110 may be implemented as widgets that interact with each other in container 200. Container 200 may provide an interface 202 that the widgets use to interact with the container and with other widgets. For example, interface 202 may provide a function that allows one widget to send a message to another widget. Or, interface 202 may provide a function that allows a widget to query the page on which the widget is located, in order to determine what content exists on that page. Additionally, interface 202 may invoke callbacks that the widgets implement, so that container 200 can provide information to the widget (either information that container 200 wants to provide to the widgets, or information that container 200 is relaying from other widgets).

For example, suppose that a user uses gallery 108 to select a particular video to view. Gallery 108 could call a function on interface 202 in order to send a message to video player 102. A parameter passed to the function could identify the widget to which the message is to be sent (i.e., to video player 102, in this example), and could also contain the content of a message to be sent to that widget (e.g., a message that tells the video player to “play video #12345”). Container 200 could then pass the message to video player 102 (e.g., by issuing a callback implemented by video player 102), and video player 102 could respond by playing the requested video. In order to play the request video, video player 102 may have to communicate with an external source, such as server 206. For example, server 206 may store a video content library. So, when video player 102 receives the message “play video #12345”, video player 102 may have to connect to server 206 in order to receive a stream of video #12345 from the content library.

The foregoing is one example of communication between widgets. However, widgets may engage in other types of communication. For example, the stream of a particular video could contain the metadata for that video, and video player 102 could send the metadata to metadata pane 104, so that metadata pane 104 can display the metadata. Or, the widgets might be on a web page that contains non-widget content (e.g., news stories, images, etc.), and gallery 108 could request that container 200 inform gallery 108 what keywords appear in text on that page. Gallery 108 could then display videos that are related to those keywords. (Gallery 108 might display such videos by generating a query on those keywords, and requesting that server 206 process the query. In response, server 206 could provide thumbnail of, and links to, videos that relate to those keywords.) Widgets could communicate any type of information with each other, and widget can draw on any type of information in order to make decisions about what actions to take.

In addition to choosing videos based on keywords that appear on a page, the following techniques could also be used to select videos:
Videos could be selected manually—e.g., an editor could use content selection tools to define various video content database queries (search keywords, display by tags, etc.) , or could manually create a specific ordered playlist of videos.
Behavioral targeting could be performed using information about users' web-browsing behavior, such as the pages users have visited or the searches they have made. (Collection of this information could be done in accordance with a privacy policy, in order to ensure that information about a person is not being used in an inappropriate manner.) This information could be used to select which videos to display to that individual. There are various ways that behavioral targeting could be done. In one example, site visitors are placed into pre-defined segments. In another example, marketers could define their own segments, which could take into account the frequency with which a person takes similar action on a given day, allowing that person to be in different groups on different days.
Users could be targeted by demographics or geographic location (again, while using an appropriate privacy policy to prevent inappropriate use of information about a person). Various factors that could be considered may include profession, industry, the size of the company a person works for, country, time zone, etc. This information could be used to determine which videos are to be shown to a particular user.
Videos could be selected based on time of day.
   Any of these techniques could be implemented using communication between widgets. For example, one widget could collect some or all of the above information, and could communicate the information (or specific lists of videos based on the information) to a gallery widget, which could then display a customized list of videos to a user.

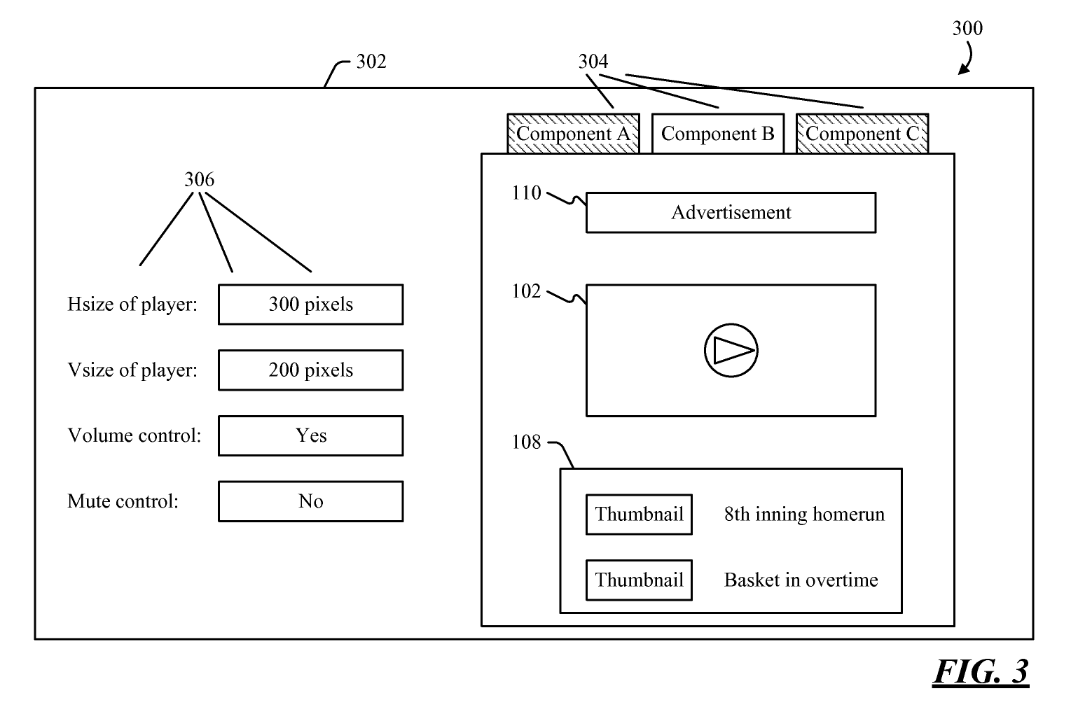

In order to design a web page (or a portion of a web page) that uses widgets, a tool may be provided to configure the widgets. The widgets described herein may have various parameters that could be chosen by a designer. FIG. 3 shows an example configuration interface that may be used with a configuration tool.

Tool 300 provides a configuration interface 302, which may be used by a web site designer (or by some other party) to configure various widgets to be used on a web page. In the example of FIG. 3, the widgets that are being configured are an advertising pane 110, a video player 102, and a gallery 108, although any type of widgets could be configured using tool 300. Configuration interface 302 may provide a plurality of tabs 304, which allow the designer to select which widget (or, more generally, which part of the user interface) is being configured. For example, in FIG. 3 three tabs are shown which are labeled “Component A”, “Component B”, and “Component C”. In this example, the absence of a stipple pattern over the “Component B” shows that Component B has focus, and is the one currently being configured. In this example, “Component B” corresponds to video player 102.

There are various parameters 306 that can be configured for video player 102. For example, the horizontal and vertical sizes at which the player is to be displayed (“hsize” and “vsize”) could be chosen by the designer. Specific controls (such as volume and mute) could be made available, or could be withheld, based on the designer's selection. (In the example of FIG. 3, the designer has chosen to make a volume control available, but has chosen not to make a mute control available.) Other aspects of a widget could be configured. For example, there could be configurable parameters that control the behavior of gallery 108—e.g., there could be a parameter that allows a designer to specify the Uniform Resource Locator (URL) of the server that will populate the list of videos that gallery 108 displays. Or, with regard to advertising pane 110, there could be one or more parameters that determine how advertising pane 110 determines which advertising content to display, or a parameter that identifies the server that provides advertising content. Widgets could be configured in any manner using tool 300.

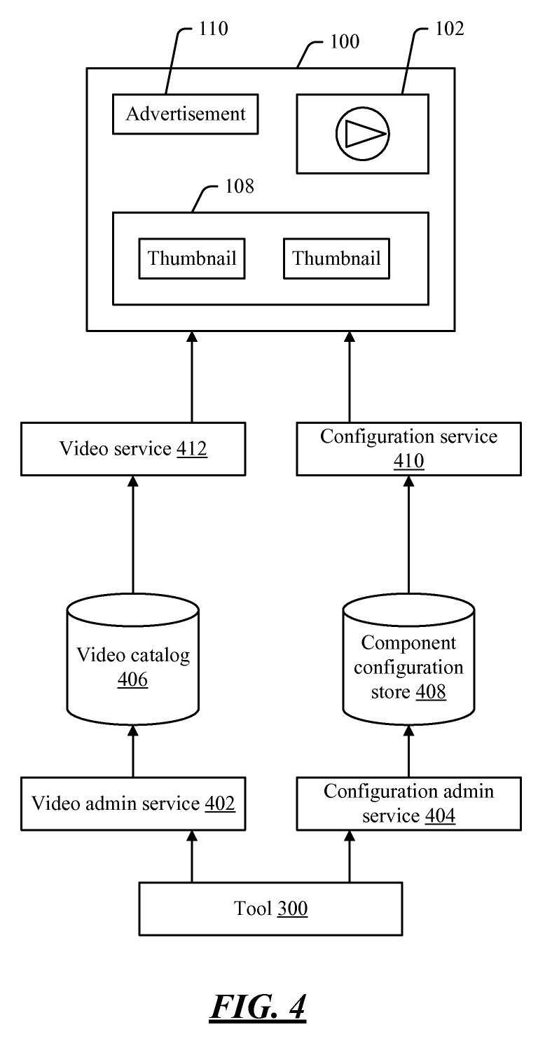

FIG. 4 shows an example of how various components may interact to create a content experience.

Tool 300 may be used to design a web page, such as web page 100. For example, tool 300 may be used to select widgets to appear on web page 100, and to configure those widgets with particular parameters. Additionally, tool 300 could be used to include other types of content on web page 100. For example, the provider of web page 100 may want to include up-to-date news content on web page 100, and tool 300 could allow a designer to specify the URL of a web site that will provide current news content. Or, tool 300 could allow a designer to include static content (e.g., the logo of the web site provider) on the page. Tool 300 may also allow the web site designer to specify the content that may be offered by the widgets on the page. For example, tool 300 could be used to specify which videos may be offered to a user by a gallery widget.

Tool 300 may perform its functions by providing an interface to various administrative services. For example, there may be a video administrative service 402 and a configuration administrative service 404. Video administrative service 402 may allow a designer to specify which videos are to be made available on web page 100, and configuration administrative service 404 may allow the designer to set the parameters of various videos (or to specify various other aspects of a web pages, such as static content, as described above).

The specific choices made by a designer may be stored in various data stores. For example, one data store may be a video catalog 406, which stores video content that is to be made available on web page 100. Another example of a data store is component configuration store 408, which stores the configurations of the various widgets that have been chosen by the designer. The various administrative services may communicate with these stores in order to store relevant information. For example, the video administrative service 402 may store videos in video catalog 406, and configuration administrative service 404 may store configuration data for the widgets in component configuration store 408.

Various services may access the stores in order to provide content on web page 100. For example, in FIG. 4 web page 100 contains video player 102, gallery 108, and advertising pane 110, which may be implemented by appropriate widgets. These widgets may have been configured in some manner by a designer, using tool 300. Moreover, the configuration settings may have been stored in component configuration store 408. Configuration service 410 may provide these settings to the widgets, so that the widgets can behave, on web page 100, in the manner specified by their configuration. Storing the configuration data in this manner may allow real time rendering of widget configuration without the web site designer's having to update/refresh the web site. The web site designer can use the tools to update a particular configuration, and the run-rime widget component can retrieve the updated configuration and can render the updates in real time. Additionally, storing configuration data may allow the implementation of extended scheduling scenarios, in which certain widget properties could be scheduled in advance to change behavior based on certain business conditions.

During the operation of the widgets, the widgets may obtain video content, or information related to video content (e.g., thumbnails, titles, etc.). This video content, or information related to video content, may be provided by video service 412. For example, if a user uses gallery 108 to select a video, then video player 102 (or the container under which video player 102 and gallery 108 operate) may request to obtain a stream of that video. Video service 412 may access the requested video in video catalog 406, and may stream the video to the machine on which web page 100 is being displayed. Services such as video service 412 and configuration service 410 may operate on a server (e.g., server 206, shown in FIG. 2), and when the widgets operate on a machine (e.g., a client machine on which a web page containing the widgets is being displayed), the widgets may access these services remotely by contacting the server through a network (e.g., through the Internet).

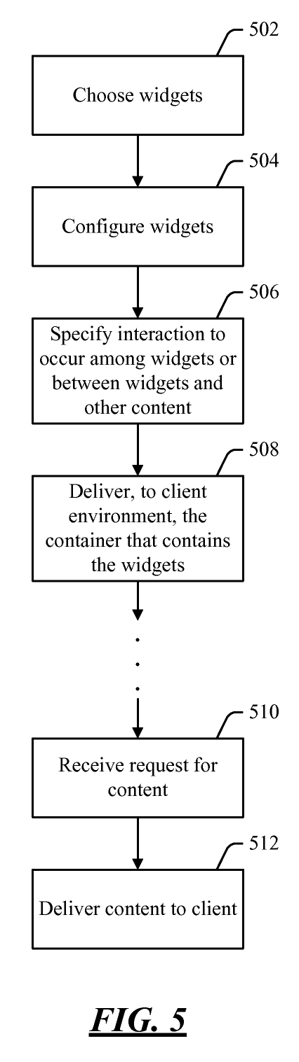

FIG. 5 shows an example process by which a web page containing widgets may be designed and/or used. Before turning to a description of FIG. 5, it is noted that FIG. 5 is described, by way of example, with reference to components shown in FIGS. 1-4, although the process of FIG. 5 may be carried out in any system and is not limited to the scenarios shown in FIGS. 1-4. Additionally, FIG. 5 shows an example in which stages of a process are carried out in a particular order, as indicated by the lines connecting the blocks, but the various stages shown in this diagram may be performed in any order, or in any combination or sub-combination.

At 502, widgets may be chosen to include in a web page. For example, a web site designer may decide to include a video player, a gallery, and an advertising pane on a web page. Thus, these widgets may be chosen at 502.

At 504, the chosen widgets may be configured. For example, the horizontal and vertical dimensions of a video player, its position on the web page, the controls that the player will offer to the user, etc., could be configured at 504. As noted above, the video player is not the only widget that could be configured. Any widget could have configuration parameters, and thus any of the widget(s) could be configured at 504.

At 506, the interaction among widgets, or between widgets and other content, is specified. For example, if video player is allowed to display a particular video upon receipt of instructions from a gallery widget, then this fact could be specified at 506. As another example, if the gallery or advertising pane widgets are to display videos or advertising content that is based on what other content appears on the web page, then the interaction between those widgets and the page's content may be specified at 506. (E.g., if the web page displays an up-to-date news story, then it could be specified at 506 that the gallery is to display lists of videos that are based on keywords that appear in the news story.)

At 508, a container that contains the widgets is delivered to the environment in which the widgets will be used. For example, widgets might be executed within container 200 (shown in FIG. 2). In this case, container 200, and the widgets that it contains, could be include as part of a web page, and that page could be delivered to a client machine. For example, on the client machine a user may use a browser to request the web page, and the web page (including the container and the widgets) could be delivered to the client in response to that request.

At some subsequent point in time (as indicated by the vertical ellipsis in FIG. 5), the operation of the widgets may generate a request for content. For example, a user's interaction with a gallery widget may result in the user's selecting a particular video (e.g., video #12345). The gallery widget may then instruct the video player widget to play that video, which may cause the video player widget to request a stream of that video from an appropriate server. Thus, at 510, a request for such content may be received by the server. In response to such a request, the appropriate content (e.g., a video stream) may be delivered to the client (at 512), and that content may be used in some manner by the widgets. For example, the requested video stream may be delivered to the client, and may be played by the video player.

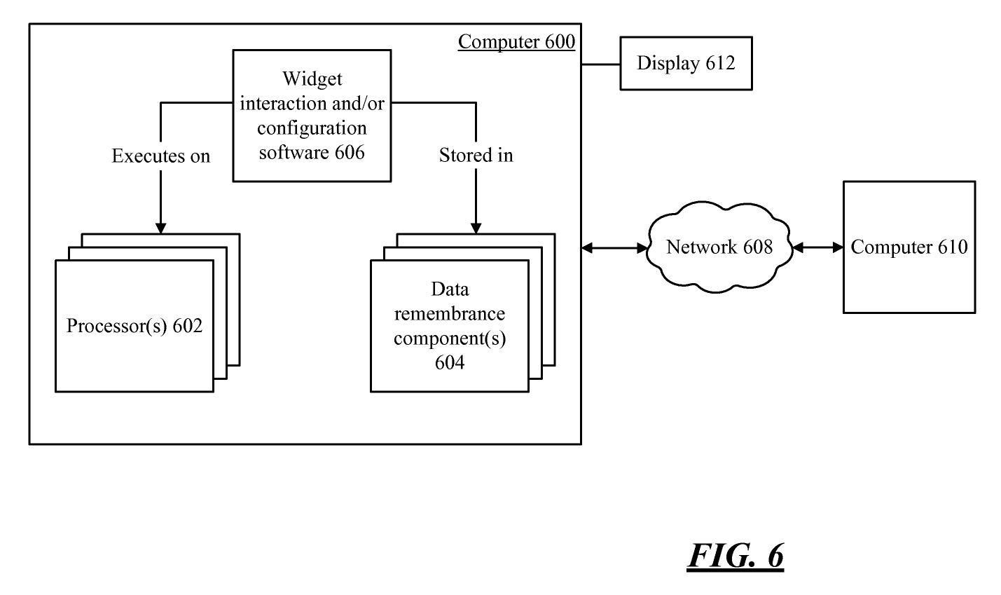

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 600 may comprise, or be associated with, display 612, which may be a cathode ray tube (CRT) monitor, a liquid crystal display (LCD) monitor, or any other type of monitor.

Software may be stored in the data remembrance component(s) 604, and may execute on the one or more processor(s) 602. An example of such software is widget interaction and/or configuration software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more computer-readable storage media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 600 may be communicatively connected to one or more other devices through network 608. Computer 610, which may be similar in structure to computer 600, is an example of a device that can be connected to computer 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of providing video content, the method comprising:
using a processor to perform acts comprising:
choosing a plurality of widgets, said plurality of widgets including a video player widget;
specifying a way in which said video player widget is to interact with other ones of said plurality of widgets;
including said plurality of widgets in a container that provides a mechanism that allows said video player widget to communicate with said other ones of said plurality of widgets; and
delivering said container to a client, wherein said client provides an environment in which said widgets execute.

2. The method of claim 1, wherein said widgets have configurable parameters, and wherein said acts further comprise:
setting said configurable parameters for one of the plurality of widgets.

3. The method of claim 1, wherein said acts further comprise:
receiving, from said container or from one of said plurality of widgets, a request for content; and
providing said content to said client in response to said request.

4. The method of claim 3, wherein said request for content comprises a request for a video, and wherein said providing of said content to said client comprises:
streaming said video to said client.

5. The method of claim 3, wherein one of said plurality of widgets comprises a gallery, wherein said request for content comprises a request for a list of videos to display in said gallery, and wherein said providing of said content to said client comprises:
providing said list of videos to displaying in said gallery, said list comprising titles of said videos or thumbnails of said videos.

6. The method of claim 1, wherein one of said plurality of widgets comprises a gallery, and wherein said specifying comprises:
specifying that said video player plays a video identified by said gallery upon an instruction that said video player receives from said gallery.

7. The method of claim 1, wherein one of said plurality of widgets comprises a metadata pane, and wherein said specifying comprises:
specifying that said metadata pane communicate with said video player to determine which video is being played by said video player, and specifying that said metadata pane display metadata about the video that is being played by said video player.

8. A computer-readable storage medium comprising executable instruction to present content to a user, wherein the executable instructions, when executed by a computer, cause the computer to perform acts comprising:
receiving a container that facilitates interaction between a plurality of widgets, said plurality of widgets comprising a video player widget and a gallery widget;
receiving, from said user through said gallery widget, an indication that said user requests to view a video;
communicating, from said gallery widget to said video player widget, a request that said video player widget play said video; and
displaying, by said video player widget, said video.

9. The computer-readable storage medium of claim 8, wherein said plurality of widgets are displayed on a web page that comprises content, and wherein said acts further comprise:
examining said web page to determine keywords that appear in said content;
determining which videos to display in said gallery based on said keywords.

10. The computer-readable storage medium of claim 8, wherein said acts further comprise:
communicating between said gallery widget and a server to determine what videos to list in said gallery widget.

11. The computer-readable storage medium of claim 8, wherein said acts further comprise:
receiving a stream of said video from a server.

12. The computer-readable storage medium of claim 8, wherein one of said plurality of widgets is a metadata pane widget, and wherein said acts further comprise:
communicating between said metadata pane widget and said video player widget to determine which video said video said video player is playing; and
displaying, by said metadata pane widget, metadata about the video that said video player is playing.

13. The computer-readable storage medium of claim 8, wherein one of said plurality of widgets is an advertising widget, and wherein said advertising widget receives information from another one of said plurality of widgets, and wherein said advertising widget displays an advertisement based on said information.

14. The computer-readable storage medium of claim 8, wherein said gallery widget displays a list of titles and thumbnail images of videos that are available to be played on said video player widget.

15. A system for displaying content to a user, the system comprising:
a processor;
a data remembrance component; and
a container that is stored in said data remembrance component, said container comprising executable components that execute on said processor, said executable components comprising:
a video player widget that plays videos; and
a gallery widget that displays a list of videos that are available to be played by said video player, said gallery widget receiving, from the user, a choice of a video from the list, said gallery widget communicating the user's choice of video to the video player widget, said video player widget playing the user's choice of video upon instruction from said gallery widget.

16. The system of claim 15, wherein said gallery widget and said video player widget communicate with each other through said container.

17. The system of claim 16, wherein said container comprises an interface through which widgets can communicate with other widgets, said interface comprises a function through which said gallery widget sends a message to said video player widget, said interface providing said message to said video player widget by invoking a function implemented by said video player widget.

18. The system of claim 15, wherein said gallery widget, said video player widget, or said container contacts a server to obtain a video that the user has chosen through said gallery widget, and wherein said system receives, from said server, a stream containing the video that the user has chosen.

19. The system of claim 15, wherein said executable components further comprise:
a metadata pane widget that communicates with said video player widget to determine which video said video player widget is playing, or to obtain, from said video player widget, metadata about the video that said video player widget is playing, said metadata pane widget displaying said metadata.

20. The system of claim 15, wherein said executable components further comprise:
an advertising widget which communicates with one or more other executable components in said container to obtain information from said one or more other executable components, and wherein said advertising widget displays and advertisement based on said information.
